(19) United States
(12) Patent Application Publication
(10) Pub. No.: US 2025/0147804 A1
(43) Pub. Date: May 8, 2025

(54) METHOD AND APPARATUS FOR DECENTRALIZED BLOCK CHAIN FOR ENABLING A PLURALITY OF CONSTRAINT IOT DEVICES

(71) Applicant: SAMSUNG ELECTRONICS CO., LTD., Suwon-si (KR)

(72) Inventor: Ravi SHARMA, Noida (IN)

(73) Assignee: SAMSUNG ELECTRONICS CO., LTD., Suwon-si (KR)

(21) Appl. No.: 19/017,043

(22) Filed: Jan. 10, 2025

Related U.S. Application Data
(63) Continuation of application No. PCT/KR2023/006063, filed on May 3, 2023.

(30) Foreign Application Priority Data
Sep. 29, 2022 (IN) 202211055968

(51) Int. Cl. G06F 9/50; G16Y 40/35; H04L 9/00

(52) U.S. Cl. CPC G06F 9/5005; G16Y 40/35; H04L 9/50; G06F 2209/5011; G06F 2209/506

(57) ABSTRACT

A method performed by a constraint internet of things (IoT) device for enabling a decentralized block chain of a plurality of constraint IoT devices, may include: creating a virtual resource pool by collecting resources of the plurality of constraint IoT devices connected in the decentralized block chain; creating a plurality of virtual nodes corresponding to the plurality of constraint IoT devices, wherein the virtual resource pool is accessible by the plurality of virtual nodes; receiving at least one first request to be executed by at least one other constraint IoT device; assigning the at least one first request to the at least one of the plurality of virtual nodes corresponding to the at least one other constraint IoT device; and allocating at least a portion of resources from the virtual resource pool to the at least one of the plurality of virtual nodes.

### CROSS-REFERENCE TO RELATED APPLICATIONS

This application is a bypass continuation of International Application No. PCT/KR2023/006063, filed on May 3, 2023, which is based on and claims priority to Indian Patent Application number 202211055968, filed on Sep. 29, 2022, in the Indian Patent Office, the disclosures of which are incorporated by reference herein in their entireties.

### BACKGROUND

### 1. Field

The present disclosure generally relates to a method and system for a decentralized block chain for enabling a plurality of constraint internet of things (IoT) devices.

### 2. Description of Related Art

An internet of things (IoT) network may refer, for example, to a network comprising of varied type of devices such as for example washing machines, refrigerators, sensors, mobiles, smart hubs, etc., which interact together to give a holistic experience to users. Different IoT devices have different capabilities. Some IoT devices have heavy storage but do not have good processing power. Some IoT devices have good processing power, but do not have local memory. Similarly, some IoT have 5G capabilities while some IoT devices do not have these 5G capabilities. For example, smart watches, smart TV and fridge have more storage but less processing power whereas voice assistants have more processing power but less storage. Hence, the IoT devices have different storage, computation and communication capabilities and majority of them don't have all of these capabilities, which is why they are called “constraint IoT Devices.”

In the related art, the IoT devices may be part of a blockchain (BC). A blockchain comprises of various nodes such as IoT devices. The blockchain provides a decentralized system and distributed ledger, where transactions between the nodes are verified by multiple nodes and recorded across the network of nodes and not governed by a central authority. Existing blockchain based IoT systems do not treat all the IoT devices as similar to each other. There is a high configuration server (which stores the complete blockchain) working as a master/HUB and a IoT device works as a slave node in the network, as shown in FIG. 1. Therefore, for each operation, an IoT devices has to communicate first with the high configuration server. As the number of devices increase, privacy and security of user data and devices is a prime concern. For example, HUB/master is a single point of failure (SPOF). Further, IoT devices are exponentially growing which results in increased surface of attack on the blockchain. Also, running security procedures on many IoT devices result in constrained computing resources of the IoT devices. For example, there may be 5 devices in the IoT network, each having different capabilities and different capacity. When these devices become block chain nodes, they cannot match each other with respect to computation power and hence the block chain becomes more centralized towards a high processing power node/server.

As the constraint IoT devices are low in resources, they cannot be a part of a true decentralized blockchain network as well as not enabled for 5G communication since the storage and processing power required are not enough to support blockchain node functionality for achieving true decentralization. Further, the transactions need to be stored on each node and each node should have comparable capacity to process blocks which are to be added to the block chain. However, due to the limitation and unavailability of resources in the constraint IoT devices, Blockchain operations and 5G communication are not possible. Further, IoT devices do not possess sufficient much capacity and power, so it is not possible for each standalone IoT device to become a standalone node. For example: sensors, CCTV, doorbells, and voice assistants do not have enough storage (or processing power) to become a standalone blockchain node which can participate in 5G services transaction validations and maintaining a block chain.

Further, IoT devices also have imbalance in their resources, e.g. some have more storage and less processing power and vice versa. There is no existing way to collectively use the overall IoT resources in balanced manner for common purpose of blockchain maintenance. The collective IoT resource pool is more but standalone resources are imbalanced, causing reduction in number of capable nodes. For example: Smart watches, Smart TV and fridge have more storage, voice assistants have more processing power.

### SUMMARY

Provided are method and system for a decentralized block chain for enabling a plurality of constraint IoT devices.

Additional aspects will be set forth in part in the description which follows and, in part, will be apparent from the description, or may be learned by practice of the presented embodiments.

According to an aspect of the disclosure, a method performed by a constraint internet of things (IoT) device for enabling a decentralized block chain of a plurality of constraint IoT devices, includes: creating a virtual resource pool by collecting resources of the plurality of constraint IoT devices connected in the decentralized block chain; creating a plurality of virtual nodes corresponding to the plurality of constraint IoT devices, wherein the virtual resource pool is accessible by the plurality of virtual nodes; receiving at least one first request to be executed by at least one other constraint IoT device; assigning the at least one first request to the at least one of the plurality of virtual nodes corresponding to the at least one other constraint IoT device; and allocating at least a portion of resources from the virtual resource pool to the at least one of the plurality of virtual nodes.

According to an aspect of the disclosure, a constraint internet of things (IoT) device for enabling a decentralized block chain of a plurality of constraint IoT devices, includes: at least one processor; and a memory storing instructions, that when executed by the at least one processor, cause the at least one processor to: create a virtual resource pool by collecting resources of the plurality of constraint IoT devices connected in the decentralized block chain; create a plurality of virtual nodes corresponding to the plurality of constraint IoT devices, wherein the virtual resource pool is accessible by the plurality of virtual nodes; receive at least one first request to be executed by at least one other constraint IoT device; assign the at least one first request to the at least one of the plurality of virtual nodes corresponding to the at least one other constraint IoT device; and allocate at least a portion of resources from the virtual resource pool to the at least one of the plurality of virtual nodes one or more embodiments

According to an aspect of the disclosure, a network includes: a first plurality of internet of things (IoT) devices; a second plurality of IoT devices; a first virtual node comprising computational resources from the first plurality of IoT devices; a second virtual node comprising computational resources from the second plurality of IoT devices; and a decentralized block chain, wherein the first virtual node and the second virtual node are configured to add blocks to the decentralized block chain based on requests from the first plurality of IoT devices and the second plurality of IoT devices.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The present disclosure will be described and explained with additional specificity and detail with the accompanying drawings.

### BRIEF DESCRIPTION OF THE DRAWINGS

above and other aspects, features, and advantages of certain embodiments of the present disclosure will be more apparent from the following description taken in conjunction with the accompanying drawings, in which:

FIG. 1 illustrates architecture of a blockchain including a plurality of IT devices, in accordance with the related art;

FIG. 2 illustrates a flow diagram depicting a method for a decentralized block chain for enabling a plurality of constraint IoT devices, in accordance with one or more embodiments of the present disclosure;

FIG. 3 illustrates a block diagram of a system for a decentralized block chain for enabling a plurality of constraint IoT devices, in accordance with one or more embodiments of the present disclosure;

FIG. 4 illustrates an exemplary virtual resource pool, in accordance with one or more embodiments of the present disclosure;

FIG. 5 illustrates storage of public data, in accordance with one or more embodiments of a present disclosure;

FIG. 6 illustrates a protocol stack of a virtual node, in accordance with one or more embodiments of the present disclosure;

FIG. 7 illustrates an exemplary state machine of a virtual node, in accordance with one or more embodiments of the present disclosure;

FIG. 8 illustrates a block diagram depicting trimming of the blockchain, in accordance with one or more embodiments of the present disclosure; and

FIG. 9 illustrates a use case of resource sharing in a blockchain, in accordance with one or more embodiments of the present disclosure.

### DETAILED DESCRIPTION

For the purpose of promoting an understanding of the principles of the present disclosure, reference will now be made to embodiments illustrated in the drawings and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in one or more embodiments”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more UEs or sub-systems or elements or structures or components proceeded by “comprises . . . a” does not, without more constraints, preclude the existence of other IoT devices or other sub-systems or other elements or other structures or other components or additional IoT devices or additional sub-systems or additional elements or additional structures or additional components.

Further, elements in the drawings are illustrated for simplicity and may not have been necessarily drawn to scale. For example, the flow charts illustrate the method in terms of the most prominent steps involved to help to improve understanding of aspects of the present disclosure. Furthermore, in terms of the construction of the system, one or more components of the system may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

The present disclosure provides techniques to use collective resources of constraint IoT devices for maintaining the block chain functionality and enabling 5G communication for constraint IoT devices.

Embodiments of the present disclosure will be described below in detail with reference to the accompanying drawings.

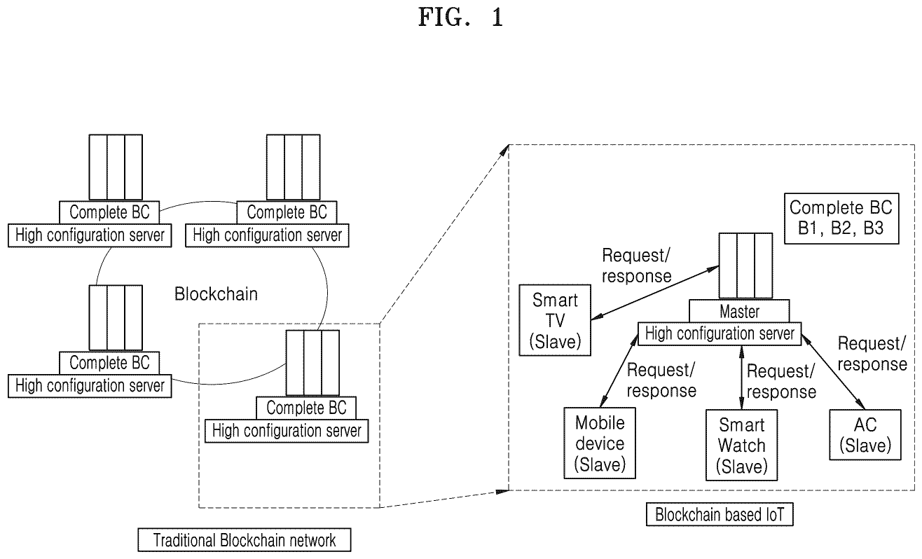

FIG. 1 illustrates architecture of a blockchain including a plurality of IoT devices, in accordance with existing art.

A blockchain provides a decentralized system and distributed ledger, where transactions are verified by multiple nodes and recorded across the network of nodes and not governed by the central authority. Referring to FIG. 1, existing blockchain (BC) system including a plurality of IoT devices does not treats all devices as similar to each other, there is always a high configuration server, which stores the complete blockchain. Examples of IoT devices may include smart TV, mobile device, smart watch, AC, etc, but are not limited thereto. The high configuration sever works as a master and an IoT device worked as slave node in the network. Therefore, for each operation, IoT devices has to communicate first with the high configuration server. True advantages of blockchain in terms of “decentralization” are not leveraged. Therefore, a paradigm to achieve true decentralization of blockchain in IoT system is needed.

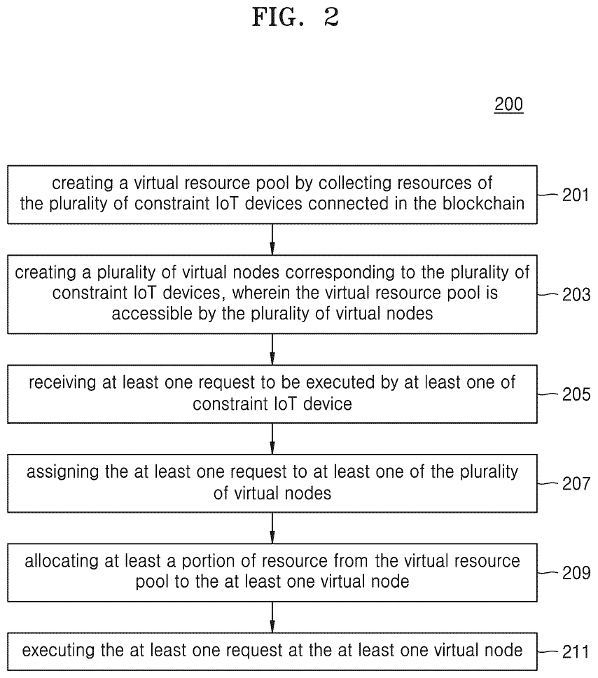

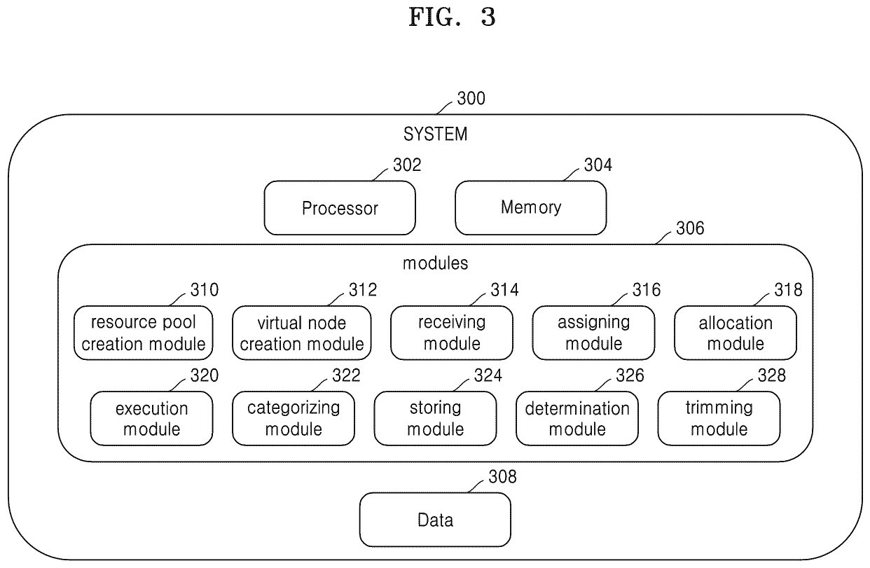

FIG. 2 illustrates a flow diagram depicting a method for a decentralized block chain for enabling a plurality of constraint IoT devices, in accordance with one or more embodiments of the present disclosure. FIG. 3 illustrates a block diagram of a system for a decentralized block chain for enabling a plurality of constraint IoT devices, in accordance with one or more embodiments of the present disclosure. For the sake of brevity, the description of the FIGS. 2 and 3 are explained in conjunction with each other.

The system 300 may include, but is not limited to, a processor 302, memory 304, units 306, and data unit 308. The units 306 and the memory 304 may be coupled to the processor 302.

The processor 302 can be a single processing module or several modules, all of which could include multiple computing modules. The processor 302 may be implemented as one or more microprocessors, microcomputers, microcontrollers, digital signal processors, central processing units, state machines, logic circuitries, and/or any UEs that manipulate signals based on operational instructions. Among other capabilities, the processor 302 is configured to fetch and execute computer-readable instructions and data stored in the memory 304.

The processor (302) may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 304 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The system (300), according to one or more embodiments of the present disclosure, may include a transceiver. The transceiver may include a RF transmitter for up-converting and amplifying a transmitted signal, and a RF receiver for down-converting a frequency of a received signal. However, according to one or more embodiments, the transceiver may be implemented by more or less components than those illustrated in components. The transceiver may be connected to the processor (302) and transmit and/or receive a signal. The signal may include control information and data, but is not limited to. In an example, data may be the at least one request described in the present disclosure. In addition, the transceiver may receive the signal through a wireless channel and output the signal to the processor (302) or other constraint IoT devices through a wireless channel. The transceiver may transmit a signal output from the processor (302) or other constraint IoT devices through the wireless channel.

The modules 306 amongst other things, include routines, programs, objects, components, data structures, etc., which perform particular tasks or implement data types. The modules 306 may also be implemented as, signal processor(s), state machine(s), logic circuitries, and/or any other system or component that manipulate signals based on operational instructions.

Further, the modules 306 can be implemented in hardware, instructions executed by a processing unit, or by a combination thereof. The processing unit can comprise a computer, a processor, such as the processor 302, a state machine, a logic array, or any other suitable IoT device capable of processing instructions. The processing unit can be a general-purpose processor which executes instructions to cause the general-purpose processor to perform the required tasks or, the processing unit can be dedicated to performing the required functions. In one or more embodiments of the present disclosure, the modules 306 may be machine-readable instructions (software) which, when executed by a processor/processing unit, perform any of the described functionalities.

In one or more embodiments, the modules 306 may include a resource pool creation module 310, a virtual node creation module 312, a receiving module 314, an assigning module 316, an allocation module 318, an execution module 320, a categorizing module 322, a storing module 324, a determination module 326 and a trimming module 328.

The various modules 310-328 may be in communication with each other. In one or more embodiments, the various modules 310-328 may be a part of the processor 302. In one or more embodiments, the processor 302 may be configured to perform the functions of modules 310-328. The data module 308 serves, amongst other things, as a repository for storing data processed, received, and generated by one or more of the modules 306.

It should be noted that the system 300 may be a part of a IoT device or IoT device itself. In one or more embodiments, the parts of system 300 may be distributed to different IoT devices.

It should be noted that in one or more embodiments of the present disclosure, the term “IoT device” may refer to “constraint IoT devices”. Different IoT devices have different capabilities. Some have heavy storage but not good processing power. Some have good processing power but local storage is not there. Some have 5G capabilities and some doesn't have any of these. Devices which are not capable enough for storing data and/or doesn't have enough processing power and/or doesn't have 5G capabilities may be considered as “constraint IoT devices” in the present disclosure. Accordingly, the terms “IoT device” and “constraint IoT devices” have been used interchangeably throughout the specification and drawings.

Referring to FIG. 2, as shown in FIG. 2, at step 201, the method 200 may comprise creating a virtual resource pool by collecting resources of the plurality of constraint IoT devices connected in the blockchain. In one or more embodiments, the resources may include capability, usage pattern and availability of the IoT devices. Table 1 below shows examples of IoT devices along with their respective availability:

TABLE 1

| IoT Device | Availability |
|---|---|
| TV | Always |
| Alexa | Always |
| Mobile | (8 PM-8 AM) |
| CCTV | Always |

Table 2 below shows examples of IoT devices along with one of the many of their respective capabilities:

TABLE 2
IoT Device - Capability

TV - Storage
VA - Processing Power
Mobile - 5G
CCTV - Storage
Sensor - Storage
VA - Storage

The various capabilities of the IoT devices may have different ranges for different IoT devices. Table 3 below shows exemplary capabilities along with their respective ranges for an exemplary IoT device:

TABLE 3

| | Example | | Example | | Example |
|---|---|---|---|---|---|
| Capability | Range | Capability | Range | Capability | Range |
| ROM | {4 MB to 256 | Processing | {Arduino to | 5G | {Yes, |
| (Storage) | GB} | Power | Cortex | Support | No} |
| | | | Series} | | |
| RAM | {1 MB to 12 | Camera | {8 MP to | Communication | {BT, |
| | GB} | | 128 MP} | | Wifi, |
| | | | | | LTE, 5G} |

Table 4 below shows examples of IoT devices along with their respective usage pattern and available capabilities:

TABLE 4

| | | Available (unused) |
|---|---|---|
| IoT Device - Capability | Usage pattern | Capability % |
| TV - RAM | Power ON / 11 PM-8 AM | 90% |
| TV - IR Sensor | In Idle mode / Always | 100% |
| TV - Storage | Power ON/ Always | 70% |

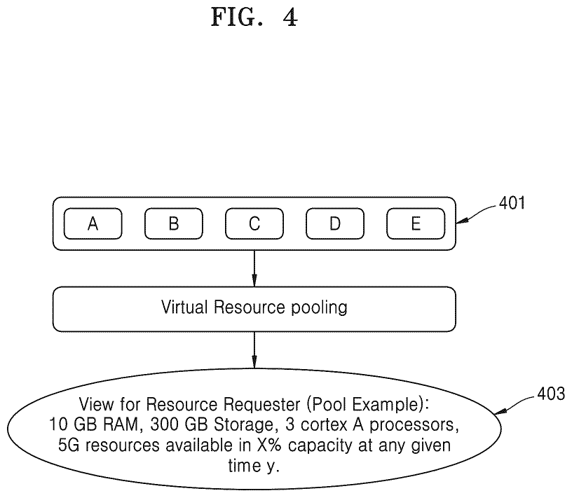

Hence, the resource pool creation module 310 may create the virtual resource pool using capability, usage pattern and availability of the IoT devices. In an exemplary embodiment, the resource pool creation module 310 may use virtualization to create a huge single pool of all the resources of constrained IoT devices, which is equally accessible to all the virtual nodes, i.e., IoT devices, requesting for it. FIG. 4 illustrates an exemplary virtual resource pool, in accordance with one or more embodiments of the present disclosure. As shown in FIG. 4, a virtual resource pool 403 may be created by pooling resources of plurality of constraint IoT devices 401.

In one or more embodiments, the resources of the IoT devices may be categorized in a plurality of predefined categories based on at least one of capability, availability and usage pattern. The examples of predefined categories may be high capability, average capability, no capability, high availability, average availability, no availability etc. The resource pool may store the resources according to the categorization. Table 5 below shows an example of categorization of resources based on their capabilities:

TABLE 5

| | Category based | |
|---|---|---|
| IoT Device - Capability | on capability | |
| TV - Storage | 8 | 10 - Highly capable |
| VA - Processing Power Mobile - 5G CCTV - Storage Sensor - Storage | 10 10 10 1 | [symbol] |
| VA - Storage | 2 | 0 - Not capable |

Referring back to FIG. 2, at step 203, the method 200 may comprise creating a plurality of virtual nodes corresponding to the plurality of constraint IoT devices. In one or more embodiments, the virtual resource pool is accessible by the plurality of virtual nodes. The virtual nodes may refer to virtual version of actual hardware with dedicated resources such as CPU, memory and 5G capability access which is actually borrowed from available actual hardware resources of the constraint IoT devices. The virtual nodes are independent uniquely identifiable virtual devices, and all of the virtual nodes are equally capable. The virtual nodes may be referred as are virtual representative of an actual constraint IoT hardware. In some embodiments, a first plurality of IoT devices may contribute computational resources to a first virtual node, and a second plurality of IoT devices may contribute computational resources to a second virtual node.

In one or more embodiments, the virtual node creation module 312 may create the plurality of virtual nodes by defining a virtual node template for each of the plurality of virtual nodes. In one or more embodiments, the virtual node template may include at least one of data to be stored at the virtual node and functionality of the virtual node.

In one or more embodiments, the categorizing module 322 may categorize a plurality of data associated with each of the constraint IoT devices into a plurality of predefined categories. In one or more embodiments, the plurality of predefined categories may include at least one of personal category, public category, essential category. For example, personal data such as wakeup time, health information, biometric information, financial information, private blockchain information, login information, facial recognition information etc. may be categorized in personal category. Similarly, data such as video footage, Image database, location and sensor data dump, public blockchain data, etc. may be categorized in public category. Further, data essential to the blockchain such as metadata, BC ledgers, etc. may be categorized in essential category.

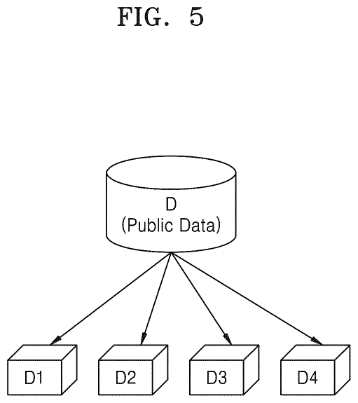

Further, in one or more embodiments, the storing module 324 may store each categorized data in a predefined manner. For example, personal data may be stored in access controlled manner. Further, personal data is not stored/shared with other devices as it is very sensitive in nature. As the public data may be huge, its metadata may be kept by all the nodes, but not all data, as shown in FIG. 5. For example, let us assume that the complete public data (D) stored at each node requires 1 GB storage. However, if the metadata (D1, D2, D3, D4) is stored at each node, then the storage required is ˜1 MB. Hence, public data may be broken and stored at several IoT devices. Essential data's copies may be stored to avoid problems due to data loss. It should be noted that only few examples of predefined manner have been explained and the data may be stored in any manner other than the explained examples. Further, the storing module 324 may store data of each of the virtual node in a dedicated memory.

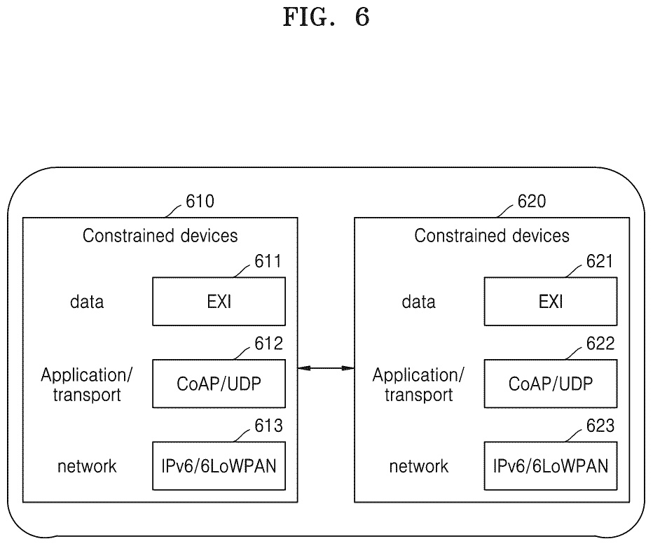

The virtual node template may further define a protocol stack for each of the constraint IoT device. The protocol stack enables the plurality of constraint IoT devices to communicate beyond their communication capabilities. For example, if any of the constraint IoT device does not have capability to communicate using 5G or higher communication standard, then the protocol stack may enable such IoT device to communicate using 5G or higher communication standard. FIG. 6 illustrates a protocol stack of a virtual node, in accordance with one or more embodiments of the present disclosure.

It should be noted that FIG. 6 illustrates an example of the protocol stack and the protocol stack may include less or more layers/components than defined in FIG. 6. Referring to FIG. 6, the protocol stack in constrained IoT devices (610, 620) may configure with data layer (e.g. EXI) (611, 621), application/transport layer (e.g. CoAP/UDP) (612, 622), and network layer (e.g. IPv6/6LoWPAN) (612, 623). As shown in FIG. 6, a constrained application protocol (CoAP) (612, 622) may be used for communication between constrained devices (610, 620) and networks. In one or more embodiments, an M2M communication protocol may be used. Using CoAP (612, 622), the 5G request related data is transferred from non 5G device to 5G device and then 5G device executes the request using its capabilities. It should be noted that any further layers may be added in CoAP (612, 622) to support higher communication standards, if required. Further, it should be noted that CoAP (612, 622) is an example and any other protocol suitable for communication between the IoT devices (610, 620), may be used.

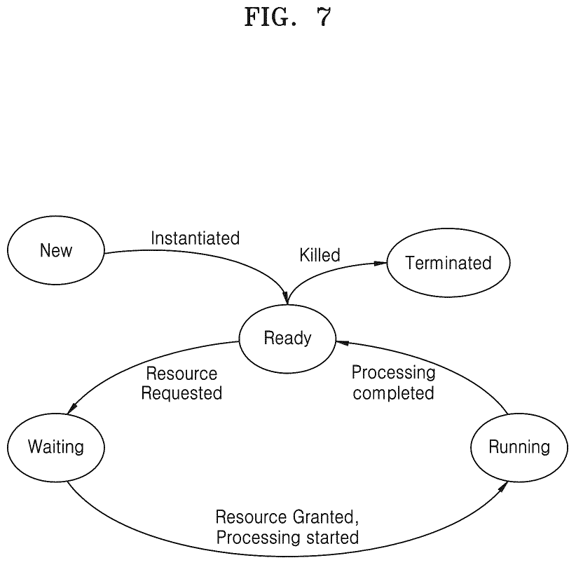

Thereafter, the virtual node creation module 312 may create a number of instances of virtual node template. In one or more embodiments, the number of instances is greater than or equal to a number of plurality of the IoT constraint devices. Then, the virtual node creation module 312 may assign a dedicated storage address to each virtual node and maintain a state machine corresponding to each virtual node to track status of the virtual node. FIG. 7 illustrates an exemplary state machine of a virtual node, in accordance with one or more embodiments of the present disclosure. As shown in FIG. 7, the state machine may maintain status of the virtual node, such as new, ready, terminated, running, waiting etc. and the process for achieve the corresponding status of the virtual node.

Referring back to FIG. 2, at step 205, the method 200 may comprise receiving at least one request to be executed by at least one of constraint IoT device. In particular, the receiving module 314 may receive the at least one request which is to be executed by the IoT device. The received request may relate to functions of the IoT device. For example, the request may be “to turn ON a fire sensor”. In another example, the request may be “show contact list of a user on a fridge”. In another example, the request may be “alerting a user of unauthorized access by a door sensor”.

Thereafter, at step 207, the method 200 may comprise assigning the at least one request to at least one of the plurality of virtual nodes. As the virtual nodes have been created corresponding to IoT devices, the assigning module 316 may assign the received request to at least one virtual node. It should be noted that the received request may be assigned to more than one virtual node.

In one or more embodiments, the assigning module 316 may assign the request based on a priority level of the request. The priority level may be identified based on a type of request associated with the received request. The type of request may be identified from a plurality of predefined types of request. In one or more embodiments, the plurality of predefined types of request may include at least one of normal request, urgent request, personal request, critical request etc. Further, each of the type of request may be associated with a priority level. For example, the critical request may have a higher priority level than the urgent, personal and normal type of requests. Similarly, the urgent request may have a higher priority level than the personal and normal type of requests.

It should be noted that the plurality of predefined types of request may include types other than defined here and any such type of request falls within the scope of the present disclosure. Similarly, the priority level for the types of request may be configured and may vary from request to request.

In an exemplary embodiment, let us assume that the receiving module 314 receives following plurality of requests:
Request 1—CCTV detects unknown person in room, sends request to alarm to go off->This is urgent request between CCTV and Alarm.
Request 2—Turning on “Smoke/Fire sensor”->This is critical (i.e., must to do) request.
Request 3—a smart watch detects high heart rate of user, inform emergency contact->this is personal and urgent request which will need 5G resources.
Request 4—Show contact list of user on fridge->this is normal request.

Accordingly, the assigning module 316 may assign each of these requests based on their priority level. For example, the requests 2 and 3 may be assigned prior to requests 1 and 4.

In one or more embodiments, the assigning module 316 may determine if more than one virtual node is available based on a type of the at least one request and may assign the at least one request to the virtual node available for a predefined time duration, if more than one virtual node is available. Continuing with the above example of received requests, if more than one virtual node such as mobile device and TV, is available to execute request 4, then the assigning module 316 may assign the request 4 to the mobile device for a predefined time duration. In one or more embodiments, the predefined time duration may be defined based on availability of the virtual node. The availability of the virtual node may be determined based on the usage pattern of the IoT device. In one or more embodiments, the assigning module 316 may assign the request to the virtual node, which is available for a longer period of time.

In one or more embodiments, the assigning module 316 may determine if the at least a portion of resource is available to be assigned. However, the at least a portion of resource is not available to be assigned, then the assigning module 316 may assign the at least one request to a waiting queue. In other words, if no resources is available to execute the received request, then the request is assigned to awaiting queue and the request is assigned to the virtual node upon availability of the resources.

Referring back to FIG. 2, at step 209, the method 200 may comprise allocating at least a portion of resource from the virtual resource pool to the at least one virtual node. As the virtual source pool is accessible to all the virtual nodes, the resources can be shared between the virtual nodes. Accordingly, the allocation module 318 may allocate the resources to the virtual nodes. In one or more embodiments, the allocation module 318 may allocate the at least a portion of resource based on a type of the at least one request. For example, if the received request require high processing capacity, then the allocation module 318 may accordingly allocate resource of high processing capacity. Similarly, if the received request require high storage capacity, then the allocation unit 318 may accordingly allocate resource of high storage capacity. In another example, if a device could be highly capable but if it is not available, then the allocation module 318 may not allocate any resources to that device.

In one or more embodiments, the allocation module 318 may determine if the available resource may be available till completion of request. If so, then the allocation module 318 may allocate the resource to the virtual node.

In one or more embodiments, the allocation module 318 may create a smart contract between the plurality of virtual nodes based on a plurality of predefined conditions. The plurality of predefined conditions may include at least one of capability, availability and usage pattern of the IoT device. The smart contract may define the resource to be shared by one virtual node with each of the other nodes. Accordingly, the allocation module 318 may allocate the at least a portion of resource based on the smart contract.

In particular, smart contracts may be used to tag each IoT request as personal/public, critical/normal, urgent etc, using device type of involved devices and request type. Accordingly, the smart contracts may define the resources to be shared between the IoT devices. For example, if the IoT device is a shared IoT device, such as television (TV), voice assistant (VA), air conditioner (AC) and the request type is normal, then the smart contract may define that all the resources of shared IoT devices can be shared with other IoT devices. On the other hand, if the IoT device is a personal IoT device, such as mobile device, smart watch etc. and the request type is normal, then the smart contract may define that only limited amount of resources of the personal IoT devices can be shared with other IoT devices. However, if the request is urgent/critical type, then the smart contract may define that all the resources of the personal IoT devices can be shared with other IoT devices.

Further, the smart contract may define time frame to share the resources based on usage pattern. Hence, the smart contract may define sharing of resources based on different conditions. Accordingly, the allocation module 318 may allocate the resources based on the smart contract. It should be noted that only few examples of the smart contract have been explained. The smart contract may define sharing of resources in any other way and such ways shall fall within the scope of the present disclosure.

In one or more embodiments, when at least two requests are received, the allocation module 318 may determine if priority level of the at least two request is equal, based on a type of the at least two requests. Then, if the priority level of the at least two request is equal, then the allocation module 318 may allocate same portion of resources. In one or more embodiments, the allocation module 318 may allocate the resources for equal time frame. However, if the priority level of the requests is not same, then the allocation module 318 may allocate the request based on the priority level. In particular, if priority level of the first request is higher than the priority level of the second request, then the allocation module 318 may allocate a first portion of resource corresponding to the first request and a second portion of resource corresponding to the second request, wherein the first portion of resource is more than the second portion of resource.

In one or more embodiments, the allocation module 318 may allocate resources to higher priority request for a longer time compared to lower priority request. In one or more embodiments, the allocation module 318 may allocate all the resources to higher priority request and then reallocate the resources to the lower priority request upon completion of higher priority request.

Referring back to FIG. 2, at step 211, the method 200 may comprise executing the at least one request at the at least one virtual node. In one or more embodiments, to execute the request, the execution module 320 may first determine if the at least one request is an authorized request. If the request is authorized request, then the execution module 320 may execute the at least one request. In one or more embodiments, request authorization may refer to validation of the request sender's authenticity i.e., authentication, malicious request identification (data access control and data authentication), irregular request frequencies (malicious request identification).

Each virtual node of the blockchain can validate the request. The first virtual node to authorize the request publishes the authorization of the request and other nodes may confirm the authorization. Upon confirmation, the virtual nodes may add the authorized request as their copy of blockchain. In particular, once a virtual node is assigned at least one request, the virtual node determines a hash complexity for the request. Based on the hash complexity and type of request, the virtual node validates the request. In the blockchain (BC), the first node among the plurality of nodes, which solves a hash problem, broadcasts the solution to all the nodes and adds solved block to its own version of blockchain. Other virtual nodes receive the solution of hash problem, they validate it. If the solution is ok, they add the block to their version of blockchain. When a block is validated and update in BC, unverified transaction's status is updated.

However, adding a block upon validation of each request results in a bigger blockchain which may result in increase of storage requirement. In one or more embodiments, this problem is addressed by trimming of the blockchain, as discussed below.

In one or more embodiments of the present disclosure, the present disclosure allows trimming of the blockchain. In other words, few blocks of the blockchain may be erased. In particular, the determination module 326 may determine if at least one block among a plurality of blocks in the blockchain is erasable, if the at least one block satisfies a predefined condition. The predefined condition may include uselessness/obsoleteness of data within the block after a predefined timeframe. The predefined timeframe may be configured by the IoT devices. Hence, if the data within the block is not useful after the predefined timeframe, then the block may be determined as erasable.

Upon determination, the trimming module 328, may define a trigger time and an execution time for trimming the blockchain. In one or more embodiments, the trigger time may be configurable and may be configured by the IoT devices. For example, the trigger time may be configured as a time when the Blockchain storage pool is filled more than 80%. In one or more embodiments, the execution time may be configurable and may be configured by the IoT devices. For example, the execution time may be configured as a time when 90% of IoT devices are available and more than 80% of IoT devices are unused. It should be noted that the above are just examples of the trigger time and execution time and blockchain trimming may be triggered and executed upon satisfaction of any other predefined condition.

Thereafter, the trimming module 328 may trim the blockchain upon completion of one of the trigger time and execution time by deleting the at least one block from the blockchain. The trimming module 328 may further update a blockchain ledger reading deletion of the block.

However, if the determination module 326 determines that the at least one block is not erasable, then the trimming module 328 may create a new blockchain by keeping all the blocks of the blockchain and may maintain a separate ledger for the new blockchain. In one or more embodiments, if the data within the block is useful after the predefined timeframe, then the block may be determined as not erasable.

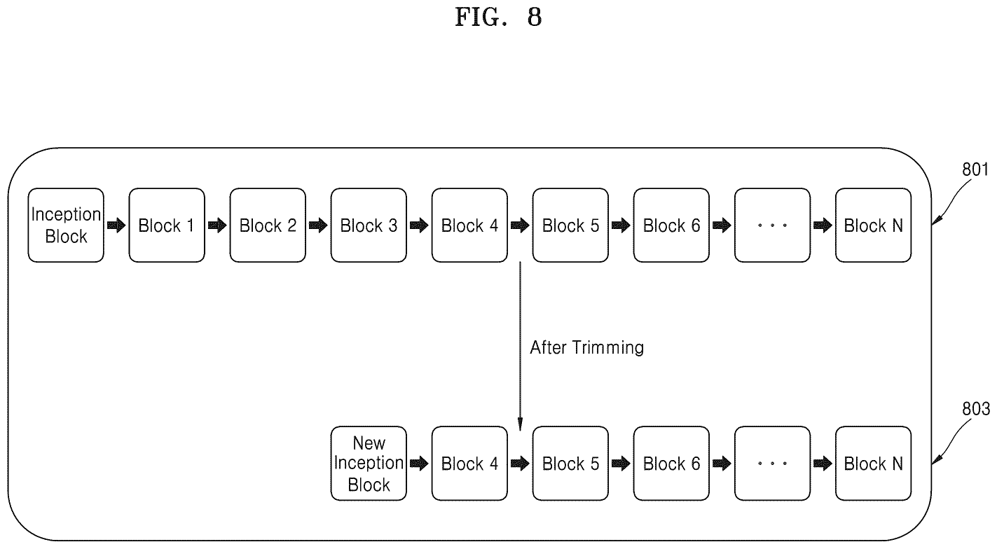

FIG. 8 illustrates a block diagram depicting trimming of the blockchain, in accordance with one or more embodiments of the present disclosure. As shown in FIG. 8, the blockchain 801 may comprise of plurality of blocks such as blocks 1 . . . block N. Blocks 1-3 are erasable and hence, these blocks are deleted to trim the blockchain. After trimming, the trimmed blockchain 803 do not include blocks 1-3, as shown in FIG. 8. Accordingly, the blockchain ledger may be updated with the trimmed blockchain 803. Also, the updated blockchain 803 may be used for upcoming requests. As the size of blockchain has been reduced by trimming, the computational overhead is reduced. Also, storage overhead is reduced because of deletion of the blocks from the blockchain.

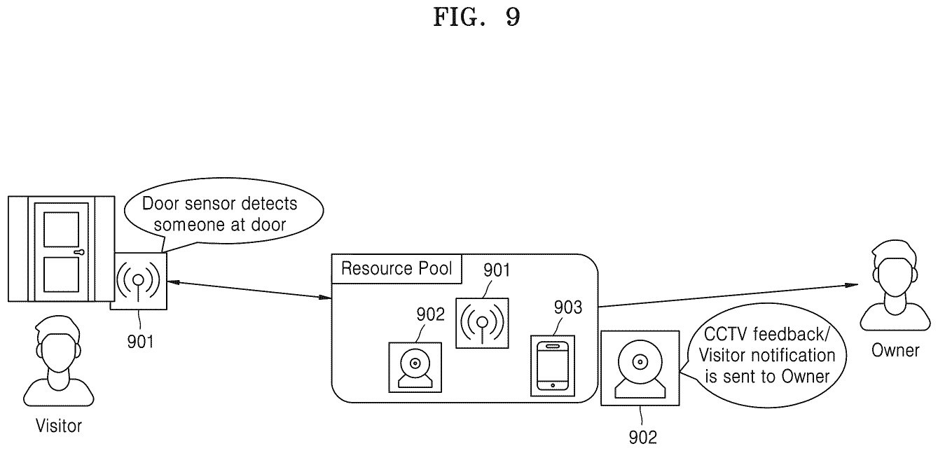

Hence, in accordance with various embodiments of the present disclosure, resource pooling provides block chain nodes which are equally capable. Further, data storage requirement is reduced as the virtual nodes stores only personal data, not public data. For public data, only metadata is stored with the virtual nodes. Further, data is not shared with cloud/outside server, thereby ensuring security of the IoT devices. For example, let us consider that there are 7 devices in IoT network, i.e., CCTV, sensor, alarm sound, TV, VA, Mobile and AC. A Sensor node (i.e., weak device) just have to keep a metadata of public block chain data and only sensor device stores its personal data. Further, when sensor node does any block validations, it has access to same resources from pool as VA node (strong processing power). Also, whatever data is accessed, it is added to block chain and controlled via smart contract. Further, Blockchain has low capability devices, which may not be able to perform various functions such as 5G communication or block chain processing. Now as the resources of all the IoT devices are pooled, the weakest device in the blockchain can also execute actions using the resources from the pool, as shown in FIG. 9.

FIG. 9 illustrates a use case of resource sharing in a blockchain, in accordance with one or more embodiments of the present disclosure. As shown in FIG. 9, there are 3 devices in the blockchain, i.e., door sensor (901), CCTV (902), Mobile (903). A door sensor (901) detects someone at door. In accordance with embodiments of the present disclosure, the door sensor (901) can access the feedback from CCTV (902) and trigger alarm. Further, the door sensor (901) may send a call/intimation/feedback to the user who is not there using any of the 5G resource of other IoT devices, such as mobile (903). Hence, the door sensor (901) is capable of executing actions outside of its capabilities, using the resources from the resource pool. All such transactions happening between devices are secure via block chain and smart contracts.

Hence, the present disclosure provides a true decentralized block chain system for enabling constraint IoT device for 5G network communication. In the examples below, a constraint IoT device, other constraint IoT devices and another constraint IoT devices may be a part of the plurality of constraint IoT devices connected in the block chain. In the examples below, other constraint IoT devices and another constraint IoT devices can be same devices.

Because the embodiments herein enable a decentralized block chain using constraint IoT devices, they are directed to a specific improvement in computer capabilities or a specific improvement to the way computers operate.

In one or more embodiments, the present disclosure discloses a method performed by a constraint IoT device for a decentralized block chain for enabling a plurality of IoT devices. The method includes creating a virtual resource pool by collecting resources of the plurality of constraint IoT devices connected in the block chain. The method further includes creating a plurality of virtual nodes corresponding to the plurality of constraint IoT devices, wherein the virtual resource pool is accessible by the plurality of virtual nodes. The method further includes receiving at least one first request to be executed by at least one of other constraint IoT devices. The method further includes assigning the at least one first request to the at least one of the plurality of virtual nodes corresponding to the at least one of the other constraint IoT devices. The method further includes allocating at least a portion of resource from the virtual resource pool to the at least one of the plurality of virtual nodes.

In one or more embodiments, the method further includes defining a virtual node template for each of the plurality of virtual nodes, wherein the virtual node template include at least one of: data to be stored at the each of the plurality of virtual nodes or functionality of the each of the plurality of virtual nodes. The method further includes creating a number of instances of virtual node template, wherein the number of instances is greater than or equal to a number of plurality of the IoT constraint devices. The method further includes assigning a dedicated storage address to the each of the plurality of virtual nodes. The method further includes maintaining a state machine corresponding to the each of the plurality of virtual nodes to track status of the each of the plurality of virtual nodes.

In one or more embodiments, the method of the present disclosure, wherein the virtual node template define a protocol stack for each of the plurality of constraint IoT devices, wherein the protocol stack enables the plurality of constraint IoT devices to communicate beyond their communication capabilities.

In one or more embodiments, the method further includes identifying a type of the at least one first request from a plurality of predefined types of request. The method further includes identifying a priority level of the at least one first request based on the identified type of the at least one first request. The method further includes assigning the at least one first request based on the priority level.

In one or more embodiments, the method of the present disclosure, wherein allocating the at least a portion of resource comprises allocating the at least a portion of resource based on a type of the at least one first request.

In one or more embodiments, the method further includes, wherein when at least two first requests are received, allocating the at least a portion of resource comprises: determining if priority level of the at least two first request is equal, based on a type of the at least two first requests. The method further includes, based on the determination, allocating the at least a portion of resource by one of: allocating same portion of resources if the priority level of the at least two first request is equal; and allocating a first portion of resource corresponding to one part of the at least two first requests and allocating a second portion of resource corresponding to other part of the at least two first requests, wherein the first portion is more than the second portion and priority level of the one part of the at least two first requests is higher than the priority level of the other part of the at least two first requests.

In one or more embodiments, the method of the present disclosure, wherein allocating the at least a portion of resource comprises: creating a smart contract between the plurality of virtual nodes based on a plurality of predefined conditions including at least one of capability, availability and usage pattern of the IoT device, wherein the smart contract defines the resource to be shared by one virtual node with each of the other nodes; and allocating the at least a portion of resource based on the smart contract.

In one or more embodiments, the method further includes receiving at least one second request to be executed by the constraint IoT device from at least one of the plurality of virtual nodes corresponding to at least one of another constraint IoT devices. The method further includes determining if the at least one second request is an authorized request. The method further includes executing the at least one second request based on the determination.

In one or more embodiments, the method further includes determining if at least one block among a plurality of blocks in the block chain is erasable, if the at least one block satisfies a predefined condition. The method further includes based upon the determination that the at least block is erasable: defining a trigger time and an execution time for trimming the block chain; trimming the block chain upon completion of one of the trigger time and execution time by deleting the at least one block from the block chain; and updating a block chain ledger. The method further includes based upon the determination that the at least block is not erasable: creating a new block chain by keeping all the blocks of the block chain; and maintaining a separate ledger for the new block chain.

In one or more embodiments, the present disclosure discloses a constraint IoT device for a decentralized block chain for enabling a plurality of IoT devices. The constraint IoT device includes a memory (304) storing instructions and at least one processor (302). The at least one processor (302) configured to execute instructions communicatively coupled to the memory (304), wherein the instructions one or more computer programs include computer-executable instructions that, when executed by the at least one processor individually or collectively, cause the constraint IoT device (300) to operations described in this disclosure.

The at least one processor are configured to execute the instructions to create a virtual resource pool by collecting resources of the plurality of constraint IoT devices connected in the block chain. The at least one processor are configured to execute the instructions to create a plurality of virtual nodes corresponding to the plurality of constraint IoT devices, wherein the virtual resource pool is accessible by the plurality of virtual nodes. The at least one processor are configured to execute the instructions to receive at least one first request to be executed by at least one of other constraint IoT devices. The at least one processor are configured to execute the instructions to assign the at least one first request to the at least one of the plurality of virtual nodes corresponding to the at least one of the other constraint IoT devices. The at least one processor are configured to execute the instructions to allocate at least a portion of resource from the virtual resource pool to the at least one of the plurality of virtual nodes.

In one or more embodiments, the at least one processor further configured to execute the instructions to define a virtual node template for each of the plurality of virtual nodes, wherein the virtual node template include at least one of: data to be stored at the each of the plurality of virtual nodes or functionality of the each of the plurality of virtual nodes. The at least one processor further configured to execute the instructions to create a number of instances of virtual node template, wherein the number of instances is greater than or equal to a number of the plurality of the constraint IoT devices. The at least one processor further configured to execute the instructions to assign a dedicated storage address to the each of the plurality of virtual nodes. The at least one processor further configured to execute the instructions to maintain a state machine corresponding to the each of the plurality of virtual nodes to track status of the each of the plurality of virtual nodes.

In one or more embodiments, the at least one processor further configured to execute the instructions to identify a type of the at least one first request from a plurality of predefined types of request. The at least one processor further configured to execute the instructions to identify a priority level of the at least one first request based on the identified type of the at least one first request. The at least one processor further configured to execute the instructions to assign the at least one first request based on the priority level.

In one or more embodiments, the at least one processor further configured to execute the instructions to allocate the at least a portion of resource based on a type of the at least one first request.

In one or more embodiments, the at least one processor further configured to execute the instructions to create a smart contract between the plurality of virtual nodes based on a plurality of predefined conditions including at least one of capability, availability and usage pattern of the IoT device, wherein the smart contract defines the resource to be shared by one virtual node with each of the other nodes. The at least one processor further configured to execute the instructions to allocate the at least a portion of resource based on the smart contract.

In one or more embodiments, the at least one processor further configured to execute the instructions to determine if at least one block among a plurality of blocks in the block chain is erasable, if the at least one block satisfies a predefined condition. The at least one processor further configured to execute the instructions to, based upon the determination that the at least block is erasable, define a trigger time and an execution time for trimming the block chain, trim the block chain upon completion of one of the trigger time and execution time by deleting the at least one block from the block chain, and update a block chain ledger. The at least one processor further configured to execute the instructions to, based upon the determination that the at least block is not erasable, create a new block chain by keeping all the blocks of the block chain and maintain a separate ledger for the new block chain.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While the disclosure has been shown and described with reference to various embodiments thereof, it will be understood by those skilled in the art that various changes in form and details may be made therein without departing from the spirit and scope of the disclosure as defined by the appended claims and their equivalents.

In addition, computer-readable storage media may be provided in the form of non-transitory storage media. The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory recording medium may include a buffer in which data is temporarily stored.

The specific examples provided to explain the embodiments according to the present disclosure are merely a combination of each standard, method, detail method, and operation, and the various embodiments described herein can be performed through a combination of at least two or more techniques among the various techniques described. In addition, at this time, it can be performed according to a method determined through a combination of one or at least two or more of the aforementioned techniques. For example, it may be possible to perform a combination of parts of the operation of one embodiment with parts of the operation of another embodiment.

What is claimed is:

1. A method performed by a constraint internet of things (IoT) device for enabling a decentralized block chain of a plurality of constraint IoT devices, the method comprising:
creating a virtual resource pool by collecting resources of the plurality of constraint IoT devices connected in the decentralized block chain;
creating a plurality of virtual nodes corresponding to the plurality of constraint IoT devices, wherein the virtual resource pool is accessible by the plurality of virtual nodes;
receiving at least one first request to be executed by at least one other constraint IoT device;
assigning the at least one first request to the at least one of the plurality of virtual nodes corresponding to the at least one other constraint IoT device; and
allocating at least a portion of resources from the virtual resource pool to the at least one of the plurality of virtual nodes.

2. The method of claim 1, wherein the creating the plurality of virtual nodes comprises:
defining a virtual node template for the plurality of virtual nodes, wherein the virtual node template comprises at least one of: data to be stored at the plurality of virtual nodes or functionality of the plurality of virtual nodes;
creating a number of instances of the virtual node template, wherein the number of instances is greater than or equal to a number of the plurality of the constraint IoT devices;
respectively assigning dedicated storage addresses to the plurality of virtual nodes; and
maintaining state machines respectively corresponding to the plurality of virtual nodes to track statuses of the plurality of virtual nodes.

3. The method of claim 2, wherein the virtual node template defines a protocol stack for the plurality of constraint IoT devices, wherein the protocol stack enables the plurality of constraint IoT devices to communicate beyond their communication capabilities.

4. The method of claim 1, wherein the assigning the at least one first request comprises:
identifying a type of the at least one first request from a plurality of predefined types of request;
identifying a priority level of the at least one first request based on the identified type of the at least one first request; and
assigning the at least one first request based on the priority level.

5. The method of claim 1, wherein the allocating the at least the portion of resources comprises:
allocating the at least the portion of resources based on a type of the at least one first request.

6. The method of claim 1, wherein based on at least two of the first requests being received, the allocating the at least the portion of resources comprises:
determining if priority level of the at least two of the first requests is equal, based on a type of the at least two of the first requests; and
based on the determining, allocating the at least the portion of resources by one of:
allocating a same portion of resources based on the priority level of the at least two of the first requests being equal; or
allocating a first portion of resources corresponding to one part of the at least two of the first requests and allocating a second portion of resources corresponding to another part of the at least two of the first requests, wherein the first portion is more than the second portion and the priority level of the one part of the at least two of the first requests is higher than the priority level of the other part of the at least two of the first requests.

7. The method of claim 1, wherein the allocating the at least the portion of resources comprises:
creating a smart contract between the plurality of virtual nodes based on a plurality of defined conditions comprising at least one of capability, availability or usage pattern of the constraint IoT device, wherein the smart contract defines the resources to be shared by one virtual node with other of the virtual nodes; and
allocating the at least the portion of resources based on the smart contract.

8. The method of claim 1, further comprising:
receiving at least one second request to be executed by the constraint IoT device, from at least one of the plurality of virtual nodes corresponding to at least one of another constraint IoT devices;
determining whether the at least one second request is an authorized request; and
executing the at least one second request based on the determining.

9. The method of claim 1, further comprising:
determining whether at least one block among a plurality of blocks in the decentralized block chain is erasable, based on the at least one block satisfying a defined condition;
in case that the at least one block is erasable:
defining a trigger time and an execution time for trimming the decentralized block chain;
trimming the decentralized block chain based on completion of one of the trigger time and the execution time by deleting the at least one block from the decentralized block chain; and
updating a block chain ledger; and
in case that the at least one block is not erasable:
creating a new decentralized block chain by keeping all the plurality of blocks of the decentralized block chain; and
maintaining a separate ledger for the new decentralized block chain.

10. A constraint internet of things (IoT) device for enabling a decentralized block chain of a plurality of constraint IoT devices, the constraint IoT device comprising:
at least one processor; and
a memory storing instructions, that when executed by the at least one processor, cause the at least one processor to:
create a virtual resource pool by collecting resources of the plurality of constraint IoT devices connected in the decentralized block chain;
create a plurality of virtual nodes corresponding to the plurality of constraint IoT devices, wherein the virtual resource pool is accessible by the plurality of virtual nodes;
receive at least one first request to be executed by at least one other constraint IoT device;
assign the at least one first request to the at least one of the plurality of virtual nodes corresponding to the at least one other constraint IoT device; and
allocate at least a portion of resources from the virtual resource pool to the at least one of the plurality of virtual nodes.

11. The constraint IoT device of claim 10, wherein the instructions further cause the at least one processor to:
define a virtual node template for the plurality of virtual nodes, wherein the virtual node template comprises at least one of: data to be stored at the each of the plurality of virtual nodes, or functionality of the each of the plurality of virtual nodes;
create a number of instances of virtual node template, wherein the number of instances is greater than or equal to a number of the plurality of constraint IoT devices;
respectively assign dedicated storage addresses to the plurality of virtual nodes; and
maintain state machines respectively corresponding to the plurality of virtual nodes to track statuses of the plurality of virtual nodes.

12. The constraint IoT device of claim 10, wherein the instructions further cause the at least one processor to:
identify a type of the at least one first request from a plurality of predefined types of request;
identify a priority level of the at least one first request based on the identified type of the at least one first request; and
assign the at least one first request based on the priority level.

13. The constraint IoT device of claim 10, wherein the instructions further cause the at least one processor to:
allocate the at least the portion of resources based on a type of the at least one first request.

14. The constraint IoT device of claim 10, wherein the instructions further cause the at least one processor to:
create a smart contract between the plurality of virtual nodes based on a plurality of defined conditions comprising at least one of capability, availability or usage pattern of the constraint IoT device, wherein the smart contract defines the resources to be shared by one virtual node with other of the virtual nodes; and
allocate the at least the portion of resources based on the smart contract.

15. The constraint IoT device of claim 10, wherein the instructions further cause the at least one processor to:
determine if at least one block among a plurality of blocks in the decentralized block chain is erasable, based on the at least one block satisfying a defined condition;
in case that the at least one block is erasable:
define a trigger time and an execution time for trimming the decentralized block chain;
trim the decentralized block chain based on completion of one of the trigger time and the execution time by deleting the at least one block from the decentralized block chain; and
update a block chain ledger; and
in case that the at least one block is not erasable:
create a new decentralized block chain by keeping all the plurality of blocks of the decentralized block chain; and
maintain a separate ledger for the new decentralized block chain.

16. A network comprising:
a first plurality of internet of things (IoT) devices;
a second plurality of IoT devices;
a first virtual node comprising computational resources from the first plurality of IoT devices;
a second virtual node comprising computational resources from the second plurality of IoT devices; and
a decentralized block chain, wherein the first virtual node and the second virtual node are configured to add blocks to the decentralized block chain based on requests from the first plurality of IoT devices and the second plurality of IoT devices.
